(19) United States
(12) Patent Application Publication
(10) Pub. No.: US 2022/0294311 A1
(43) Pub. Date: Sep. 15, 2022

(54) ACTUATOR

(71) Applicant: SONY GROUP CORPORATION, TOKYO (JP)

(72) Inventor: KIRILL VANHEERDEN, TOKYO (JP)

(21) Appl. No.: 17/639,663

(22) PCT Filed: Aug. 28, 2020
(86) PCT No.: PCT/JP2020/032654

§ 371 Date: Mar. 2, 2022

(30) Foreign Application Priority Data
Sep. 11, 2019 (JP) 2019-165309

(51) Int. Cl. H02K 7/116; F16H 1/28; H02K 19/10; H02K 11/20

(52) U.S. Cl. CPC H02K 7/116; F16H 1/28; H02K 19/10; H02K 11/20

(57) ABSTRACT

Provided is an actuator that achieves a high energy efficiency at a low speed while having a compact configuration. The actuator includes a stator and a rotor. The stator has a disk, a pillar including a permanent magnet, and a coil wound around the pillar. The rotor is provided movably along an outer edge of the disk with the rotor being in contact with the outer edge of the disk. The coil is configured to form, through energization of the coil, a magnetic circuit that passes through the disk, the pillar, and the rotor. The disk includes a first part and a second part that are disposed alternately along the outer edge of the disk, in which the first part has a first magnetic permeability and the second part has a second magnetic permeability that is higher than the first magnetic permeability.

### TECHNICAL FIELD

The present disclosure relates to an actuator.

### BACKGROUND ART

An actuator has been used in various devices. For example, a robot arm is known in which a force control type actuator is provided at a joint section and in which a plurality of arms is coupled via the joint section.

For example, Patent Literature 1 below describes a rotary actuator that includes an electric motor and a speed reducer. The electric motor has a rotor having a rotor shaft, and a cyclic-shaped stator having a plurality of coil sections projecting on the rotor side. The speed reducer has a sun gear attached to an eccentric section of the rotor shaft, and a ring gear having inner teeth engaged with outer teeth of the sun gear.

### CITATION LIST

### Patent Literature

Patent Literature 1: Japanese Unexamined Patent Application Publication No. 2009-177982

### SUMMARY OF THE INVENTION

Incidentally, it is desirable that an actuator achieve a high energy efficiency at a low speed while having a compact configuration.

An actuator according to one embodiment of the present disclosure includes a stator and a rotor. The stator has a disk, a pillar including a permanent magnet, and a coil wound around the pillar. The rotor is provided movably along an outer edge of the disk with the rotor being in contact with the outer edge of the disk. The coil is configured to form, through energization of the coil, a magnetic path that passes through the disk, the pillar, and the rotor. The disk includes a first part and a second part that are disposed alternately along the outer edge of the disk, in which the first part has a first magnetic permeability and the second part has a second magnetic permeability that is higher than the first magnetic permeability.

In the actuator according to one embodiment of the present disclosure, when the magnetic path is formed by energizing the coil, the rotor receives a force in which a reactance of the magnetic path approaches the minimum. The rotor is in contact with the outer edge of the disk, and the first part having the first magnetic permeability and the second part having the second magnetic permeability that is higher than the first magnetic permeability are alternately disposed at the outer edge of the disk. Accordingly, the rotor moves toward the second part in which the reactance of the magnetic path is further reduced.

### BRIEF DESCRIPTION OF THE DRAWINGS

FIG. 1 is a cross-sectional perspective diagram illustrating an actuator according to one embodiment of the present disclosure.

FIG. 2 is a cross-sectional diagram illustrating the actuator illustrated in FIG. 1.

FIG. 3A is a plan diagram illustrating a planar shape of a disk illustrated in FIG. 1.

FIG. 3B is another plan diagram illustrating a planar shape of a disk illustrated in FIG. 1.

FIG. 4 is a partially-ruptured perspective diagram illustrating a portion of an inner configuration of the actuator illustrated in FIG. 1.

FIG. 5 is a partially-enlarged perspective diagram illustrating the actuator for describing an outline of an operation of the actuator illustrated in FIG. 1.

FIG. 6 is a schematic plan diagram for describing an operation principle of the rotor.

FIG. 7 is a schematic cross-sectional diagram for describing the operation principle of the rotor.

FIG. 8 is a partially-enlarged perspective diagram illustrating, in an enlarged fashion, a main part of an actuator according to a first modification example (modification example 1).

FIG. 9 is a perspective diagram illustrating an actuator according to a second modification example (modification example 2).

FIG. 10 is a plan diagram illustrating, in an enlarged fashion, an actuator according to a third modification example (modification example 3).

FIG. 11 is a schematic diagram that describes an application example of the actuator according to the present disclosure.

### MODES FOR CARRYING OUT THE INVENTION

In the following, embodiments of the present disclosure are described in detail with reference to the drawings. The description will be made in the following order.
1. Background
2. One Embodiment

2-1. Configuration of Actuator

2-2. Operation of Actuator

2-3. Effects
3. Modification Examples

### 1. BACKGROUND

First, a background to the creation of a technique of the present disclosure will be described.

For example, in a case where three functions of a motor, a gear, and a brake are necessary, three independent components including the motor, the gear, and the brake have been brought together to form an actuator. However, this method reduces a ratio of an output torque to a total weight.

Accordingly, the present disclosure is designed to improve the ratio of the output torque to the total weight by effectively reusing motor components instead of using a plurality of components. Specifically, first, a planetary gear (a planetary gear) is used as a rotor of a motor and is also used as a gear upon outputting a driving force of the motor to the outside at a predetermined torque. Next, a magnetization and a demagnetization of a permanent magnet are performed by generating a magnetic flux with use of a coil so as to achieve a so-called memory motor. That is, on and off of a brake is made controllable.

Hereinafter, one embodiment will be described in detail.

### 2. ONE EMBODIMENT

[2-1 Configuration of Actuator 10]

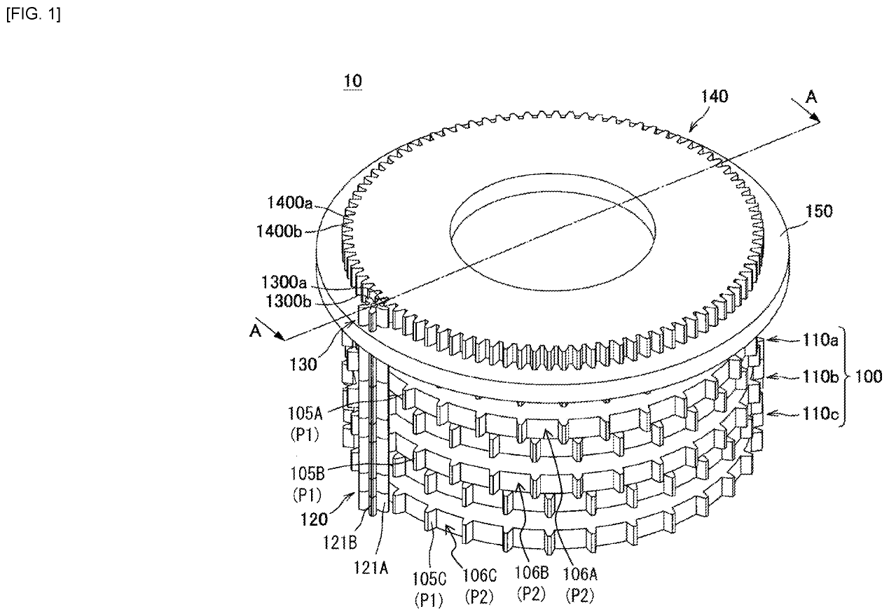

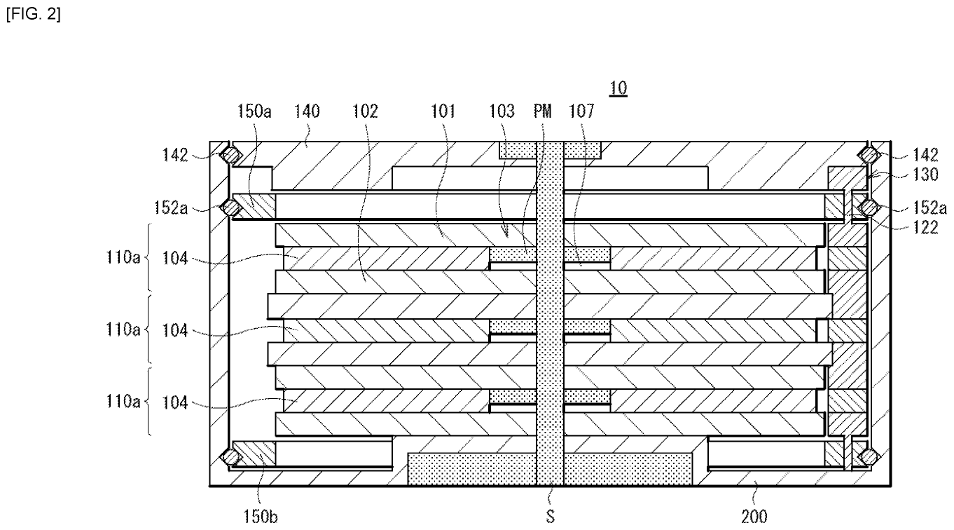

FIG. 1 illustrates an example of a perspective configuration of an actuator 10 according to one embodiment of the present disclosure. FIG. 2 illustrates an example of a cross-sectional configuration through the center of the actuator 10.

Referring to FIG. 1, the actuator 10 includes a stator 100, a rotor 120, a planetary gear 130, a sun gear 140 for output, and a carrier 150 in, for example, a substantially cylindrical housing 200. However, it is illustrative and non-limiting, and the actuator 10 may not have the housing 200, for example.

(Stator 100)

The stator 100 includes: two disks 101 and 102 that are disposed to face each other, for example; a pillar 103 including a permanent magnet PM; and a coil 104 wound around the pillar 103. The pillar 103 and the coil 104 are interposed between the disk 101 and the disk 102. The pillar 103 is so provided as to stand on surfaces of the two disks 101 and 102. For example, an upper end of the pillar 103 is coupled to the vicinity of the center of the disk 101, and a lower end of the pillar 103 is coupled to the vicinity of the center of the disk 102. An outer edge of the coil 104 is at a position retracted inwardly of an outer edge of the disk 101 and an outer edge of the disk 102.

The disks 101 and 102, the pillar 103, and the rotor 120 may include a high magnetic permeability material such as permalloy (NiFe) or soft ferrite, besides iron (Fe), for example. However, for example, it is possible to use various magnets such as alnico magnet or hard ferrite, or neodymium iron boron as the permanent magnet PM included in the pillar 103. Further, as a constituent material of the coil 104, for example, a nonmagnetic high-electric-conductivity material such as Cu is suitably used.

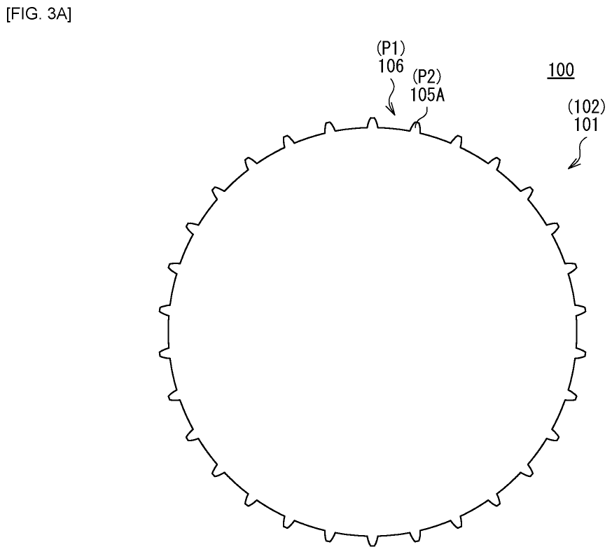

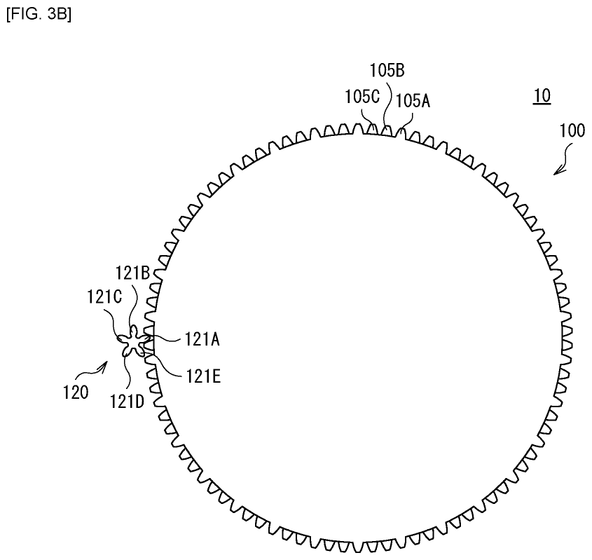

For example, as illustrated in FIG. 3A, the disks 101 and 102 each include a first part P1 having a first magnetic permeability and a second part P2 having a second magnetic permeability that is higher than the first magnetic permeability. The first part P1 and the second part P2 are alternately disposed along the outer edge of the disk 101 or 102. The number of first parts P1 of the disk 101 and the number of first parts P1 of the disk 102 are the same as each other, and are provided at positions where the first parts P1 overlap each other when viewed in a direction in which the disk 101 and the disk 102 face each other (in a rotation axis direction of the rotor 120). Similarly, the number of second parts P2 of the disk 101 and the number of second parts P2 of the disk 102 are the same as each other, and are provided at positions where the second parts P2 overlap each other when viewed in the direction in which the disk 101 and the disk 102 face each other (in the rotation axis direction of the rotor 120). Note that, in the present embodiment, the disks 101 and 102 each include a gap 106 as the first part P1, and a first outer tooth 105 as a second part P2. Note that FIG. 3A is a plan diagram illustrating a planar shape of the disk 101 or 102 illustrated in FIG. 1.

The coil 104 is configured to form, through energization of the coil 104, a magnetic path FP (described later) that passes through the disks 101 and 102, the pillar 103, and the rotor 120. The coil 104 may be configured to impart a magnetic field having a magnetic flux density that is greater than a coercivity of the permanent magnet PM.

The stator 100 may further include, at a portion of the magnetic path FP, a sensor 107 that detects a magnetic flux of the magnetic path FP. In this case, the actuator 10 may further include a controller 300 (described later) to control a voltage to be supplied to the coil 104 on the basis of the magnetic flux FP detected by the sensor 107. It is possible to use, for example, a GMR (giant magnetoresistive) element or a Hall element as the sensor 107.

The stator 100 has a structure in which a plurality of units 110 is stacked. The plurality of units each have the disks 101 and 102, the pillar 103, and the coil 104. Specifically, the present embodiment exemplifies a structure in which three units 110a to 110c are sequentially stacked. It is to be noted that the number of plurality of units 110 is preferably three or more. This is because such a configuration allows the rotor 120 to smoothly rotate along the outer edge of the stator 100, as will be described later. As illustrated in FIG. 2, the plurality of units 110 may be integrally held by a screw S or the like that penetrates, for example, central parts of the respective units 110 in the stacking direction.

Shapes and dimensions of the respective three units 110a to 110c may be substantially the same as each other. For example, shapes of outer circumferential surfaces of the respective units U are substantially the same as each other. More specifically, the outer circumferential surfaces of the respective units 110, i.e., outer circumferential surfaces of the respective disks 101 and 102 of each of the units 110 may be arranged with substantially the same number of first outer teeth 105 having substantially the same shape as each other. Further, when viewed in the stacking direction (the rotation axis direction of the rotor 120) of the plurality of units 110a to 110c, first outer teeth 105A of the unit 110a, first outer teeth 105B of the unit 110b, and first outer teeth 105C of the unit 110c are so combined as to be located at positions not overlapped with one another (located at different positions). For example, as illustrated in FIG. 3B, it is desirable that respective intervals, in a circumferential direction along the outer edges of the disks 101 and 102, of the first outer teeth 105A, the first outer teeth 105B, and the first outer teeth 105C of the three units 110a to 110c be substantially equal when viewed in the rotation axis direction of the rotor 120. This is because such a configuration allows the rotor 120 to smoothly rotate along the outer edge of the stator 100, as will be described later. Note that FIG. 3B is a plan diagram illustrating a planar shape of each of the disks 101 and 102 in the unit 110a to 110c illustrated in FIG. 1.

Further, shapes and dimensions of the coils 104 of the respective units 110a to 110c may be substantially the same as each other. In addition, shapes and dimensions of the permanent magnets PM of the respective units 110a to 110c may be substantially the same as each other.

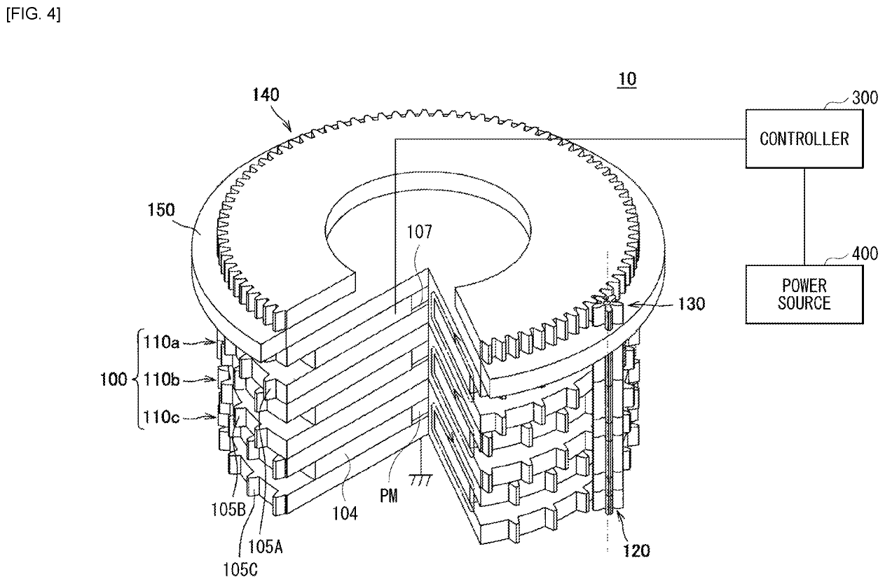

FIG. 4 is a partially-ruptured perspective diagram illustrating a portion of an inner configuration of the actuator 10. For example, the coils 104 of the respective units 110a to 110c are energized via a power cable or the like from a power source 400 disposed outside the actuator 10. In addition, a supply of electric power to the coils 104 of the respective units 110a to 110c is controlled by a controller 300 disposed, for example, inside the actuator 10. With these power source 400 and controller 300, the coils 104 in the respective units 110a to 110c form the magnetic path FP that passes through the disks 101 and 102, the pillar 103, and the rotor 120. It should be noted that if a direction of a current for each coil 104 is switched in the opposite direction, an orientation of a magnetic flux flowing through the magnetic path also turns in the opposite direction, and orientations of magnetic poles of the respective units 110a to 110c each may be reversed.

Here, the controller 300 may include a processing circuit such as CPU (Central Processing Unit) or GPU (Graphics Processing Unit). The controller 300 may collectively control operations of the actuator 10. Note that the controller 300 is not limited to an example in which the controller 300 is disposed inside the actuator 10, and may be disposed outside the actuator 10. In addition, the power source 400 is also not limited to an example in which the power source 400 is disposed outside the actuator 10, and may be disposed inside the actuator 10. The controller 300 sequentially energizes the coils 104 in the respective plurality of units 110a to 110c to form the magnetic paths FP in the plurality of units 110a to 110c.

(Rotor 120)

The rotor 120 is provided movably along the outer edges of the disks 101 and 102 with the rotor 120 being in contact with the outer edges of the disks 101 and 102. Specifically, the rotor 120 revolves along the outer edges of the disks 101 and 102 while rotating about a rotation axis 120J that extends in a direction in which the disk 101 and the disk 102 face each other, i.e., extends in the stacking direction of the plurality of units 110a to 110c.

As illustrated in FIG. 3B and the like, the rotor 120 includes second outer teeth 121 (121A to 121E) that engage with the first outer teeth 105, for example, and the rotor 120 rotates and revolves with the second outer teeth 120 being engaged with the first outer teeth 105 of the disks 101 and 102. Note that the rotor 120 has the same shape along the rotation axis 120J, and is in contact with the outer edges of the disks 101 and 102 of the respective plurality of units 110a to 110c. However, a timing at which the second outer tooth 121 engages with the first outer tooth 105A, a timing at which the second outer tooth 121 engages with the first outer tooth 105B, and a timing at which the second outer tooth 121 engages with the first outer tooth 105C are different from each other. That is, the second outer tooth 121 does not come into engagement with the first outer teeth 105A to 105C at the same time.

The rotor 120 also has a third magnetic permeability that is higher than the first magnetic permeability of the first parts P1 of the outer edges of the disks 101 and 102. For example, the third magnetic permeability of the rotor 120 may be the same as the second magnetic permeability of the second parts P2 (i.e., the first outer teeth 105) of the disks 101 and 102.

(Planetary Gear 130)

The planetary gear 130 rotates about a center axis of the stator 100 in accordance with the rotation of the rotor 120, with the planetary gear 130 being engaged with the sun gear 140. In addition, the number of outer teeth 1300 of the planetary gear 130 and the number of second outer teeth 121 of the rotor 120 may be designed to be the same as each other.

Here, the number of first outer teeth 105 arranged on the outer circumferential surface of the stator 100 may be designed to be less by the predetermined number than the number of teeth 1400 of the outer circumferential surface of the sun gear 140. For example, the number of teeth of the sun gear 140 may be N+1, where the number of first outer teeth 105 of the stator 100 is N.

(Sun Gear 140)

As illustrated in FIG. 1, the sun gear 140 is disposed more on an inner side than the planetary gear 130 with respect to the center axis of the stator 100. In addition, the sun gear 140 rotates with the teeth 1400 of the outer circumferential surface of the sun gear 140 being engaged with the outer teeth 1300 of the planetary gear 130. A rotation axis of the sun gear 140 is, for example, coaxial with the center axis of the stator 100. Here, a reduction ratio G is expressed by the following expression:

G=(Np·Ns1)/{(Np·Ns1)−(Ns2Np)}

where the number of outer teeth 1300 of the planetary gear 130 is Np, the number of first outer teeth 105 of the stator 100 is Ns1, and the number of teeth 1400 of the sun gear 140 is Ns2.

The sun gear 140 may be rotatably supported about the center axis of the stator 100. For example, as illustrated in FIG. 2, a bearing 142 is disposed between the housing 200 and the sun gear 140. In this case, the bearing 142 rotatably supports the sun gear 140 about the center axis of the stator 100.

Further, the sun gear 140 may be coupled to an output shaft (not illustrated) of the actuator 10. However, it is illustrative and non-limiting, and the sun gear 140 may be the output shaft of the actuator 10.

(Carrier 150)

The carrier 150 is ring-shaped. The carrier 150 is fixed between the rotor 120 and the planetary gear 130.

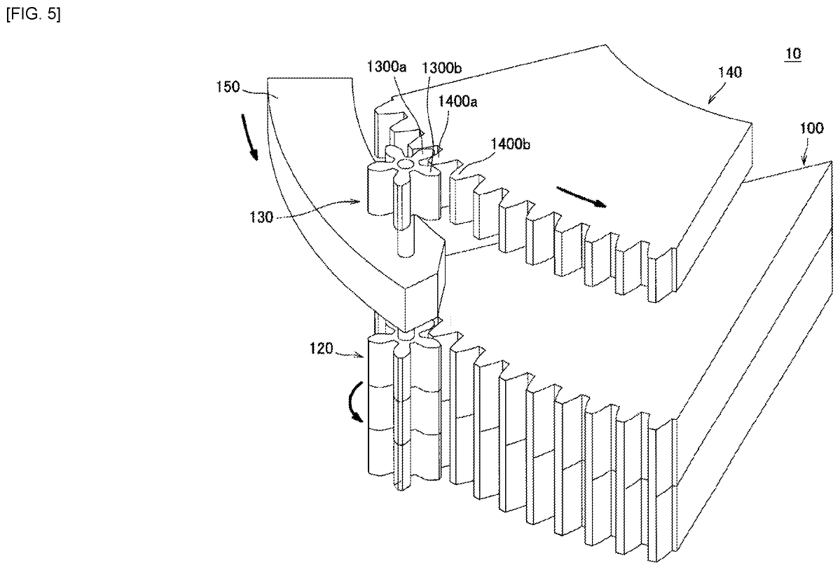

The carrier 150 may be rotatably supported about the center axis of the stator 100. For example, as illustrated in FIG. 2, the bearing 152 is disposed between the housing 200 and the carrier 150. In this case, the bearing 152 rotatably supports the carrier 150 about the center axis of the stator 100. According to the above configuration, when the rotor 120 starts to rotate about the center axis of the stator 100, a rotational force of the rotor 120 is transmitted to the carrier 150 fixed to the rotor 120. Thus, the carrier 150, together with the rotor 120, may rotate about the center axis of the stator 100, for example, as indicated by an arrow in FIG. 5.

Note that, although FIG. 2 illustrates an example in which one carrier 150 is disposed on each end side in the axial direction of the stator 100, the present embodiment is not limited to such an example. For example, as illustrated in FIG. 1, only one carrier 150 may be disposed on one end side (on the sun gear 140 side) in the axial direction of the stator 100.

(Housing 200)

As illustrated in FIG. 2, the stator 100, the rotor 120, the sun gear 140, the bearing 142, the bearing 152, and the like may be disposed in the housing 200. In addition, the housing 200 may support the stator 100, the bearing 142, the bearing 152, and the like. Note that a shape of the housing 200 is not particularly limited. For example, the housing 200 may be cylindrical or prismatic (such as a square prism).

[2-2 Operation of Actuator 10]

Next, referring to FIGS. 5 to 7, an operation of the actuator 10 based on the above-described configuration will be described.

(Outline)

First, referring to FIG. 5, an outline of an operation of the actuator 10 will be described. FIG. 5 is a partially-enlarged perspective diagram illustrating the actuator 10 for describing the outline of the operation of the actuator 10. When the magnetic paths FP of the respective three units 110a to 110c are sequentially formed at positions of the rotor 120 corresponding to the respective three units 110a to 110c, the rotor 120 starts to rotate along the outer edge of the stator 100 with the second outer teeth 121 of the rotor 120 being sequentially engaged with the first outer teeth 105A to 105C of the stator 100. It should be noted, however, that FIG. 5 illustrates only the first outer teeth 105A of the unit 110a. Thus, the planetary gear 130, which is coaxially coupled to the center axis of the rotor 120, starts to rotate (together with the rotor 120) about the center axis of the stator 100 with the planetary gear 130 being engaged with the sun gear 140. As a result, the sun gear 140 also starts to rotate about the center axis of the stator 100. At this time, an output torque may increase depending on a ratio (the reduction ratio) between the number of first outer teeth 105 of the stator 100 and the number of teeth of the sun gear 140.

In addition, the rotation of the rotor 120 may also allow the carrier 150 to rotate (together with the rotor 120) about the center axis of the stator 100.

(Principle of Rotation of Rotor 120)

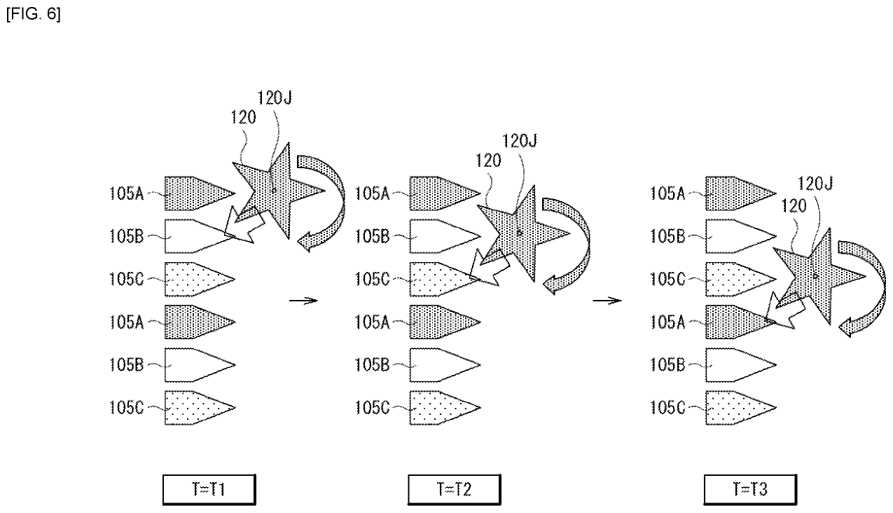

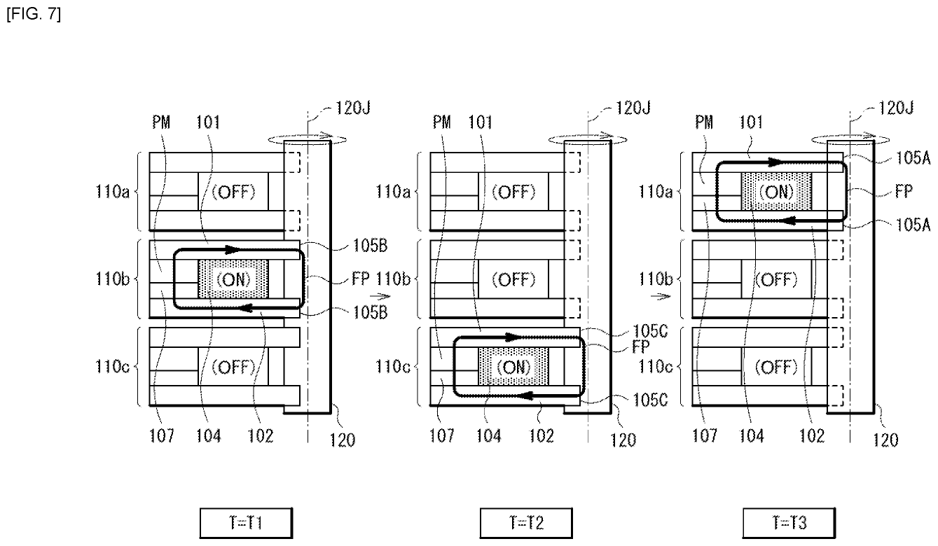

Next, referring to FIGS. 6 and 7, a principle of rotation of the rotor 120 will be described in more detail. FIG. 6 is a schematic plan diagram for describing an operation principle of the rotor 120. Specifically, FIG. 6 illustrates a positional relationship between the first outer teeth 105 of the disks 101 and 102 and (the second outer teeth 121 of) the rotor 120 at each time T=T1 to T3 during the operation of the actuator 10. FIG. 7 is a schematic cross-sectional diagram for describing the operation principle of the rotor 120. Specifically, FIG. 7 illustrates a positional relationship between the first outer teeth 105 of the disks 101 and 102 and (the second outer teeth 121 of) the rotor 120 at each time T=T1 to T3 during the operation of the actuator 10. Note that FIGS. 6 and 7 illustrate an example in which an interval between the time T1 and the time T2, an interval between the time T2 and the time T3, and an interval between the time T3 and the time T1 are all equal.

First, as illustrated in the leftmost drawing of FIG. 6 and the leftmost drawing of FIG. 7, it is assumed that the second outer tooth 121 of the rotor 120 is engaged with the first outer tooth 105A of the unit 110a at the time T1. In this state, when only the coil 104 of the unit 110b among the units 110a to 110c is turned on under the control of the controller 300, the magnetic path FP is formed inside the unit 110b as illustrated in the leftmost drawing of FIG. 7. At this time, in a case where the permanent magnet PM of the unit 110a is magnetized, the permanent magnet PM of the unit 110a is demagnetized. In this case, for example, a demagnetization pulse that is larger than the coercivity of the permanent magnet PM of the unit 110a may be applied to the permanent magnet PM of the unit 110a. As the coil 104 of the unit 110b is turned on, the rotor 120 receives a force in which the reactance of the magnetic path FP of the unit 110b approaches the minimum. That is, as illustrated in the leftmost drawing of FIG. 6, the rotor 120 moves, while rotating about the rotation axis 120J, toward the first outer tooth 105B having the higher magnetic permeability than the gap 106B (FIG. 1) in the unit 110b. For the sake of convenience, this operation will be referred to as phase 1.

Further, in the phase 1, when the coil 104 of the unit 110b is energized to form the magnetic path FP, a magnetic field having a strength that exceeds the coercivity of the permanent magnet PM of the unit 110b is applied to the permanent magnet PM of the unit 110b, and the permanent magnet PM is magnetized along the magnetic path FP. Thus, a force that interferes with (brakes) the rotational operation of the rotor 120 is sufficiently increased. A reason why the braking force to the rotor120 is increased in this manner is that the permanent magnet PM generates a force that attracts the rotor 120 as a result of the magnetization of the permanent magnet PM. Thus, the rotor 120 attempts to remain engaged with the first outer tooth 105B.

At the subsequent time T2, as illustrated in the middle drawing of FIG. 6 and in the middle drawing of FIG. 7, the second outer tooth 121 of the rotor 120 is in engagement with the first outer tooth 105B of the unit 110b as a result of the phase 1described above. In this state, the coil 104 of the unit 110b is turned off and only the coil 104 of the unit 110c is turned on, under the control of the controller 300. At this time, the permanent magnet PM of the unit 110b is demagnetized. In this case, for example, a demagnetization pulse that is larger than the coercivity of the permanent magnet PM of the unit 110b may be applied to the permanent magnet PM of the unit 110b. As a result, as illustrated in the middle drawing of FIG. 7, the magnetic path FP inside the unit 110b disappears, and the magnetic path FP is formed inside the unit 110c, which in turn causes the rotor 120 to receive a force in which the reactance of the magnetic path FP of the unit 110c approaches the minimum. That is, as illustrated in the middle drawing of FIG. 6, the rotor 120 moves, while rotating about the rotation axis 120J, toward the first outer tooth 105C having the higher magnetic permeability than the gap 106C (FIG. 1) in the unit 110c. For the sake of convenience, this operation will be referred to as phase 2.

At the subsequent time T3, as illustrated in the rightmost drawing of FIG. 6 and in the rightmost drawing of FIG. 7, the second outer tooth 121 of the rotor 120 is in engagement with the first outer tooth 105C of the unit 110c as a result of the phase 2 described above. In this state, the coil 104 of the unit 110c is turned off and only the coil 104 of the unit 110a is turned on, under the control of the controller 300. At this time, the permanent magnet PM of the unit 110c is demagnetized. In this case, for example, a demagnetization pulse that is larger than the coercivity of the permanent magnet PM of the unit 110c may be applied to the permanent magnet PM of the unit 110c. As a result, as illustrated in the rightmost drawing of FIG. 7, the magnetic path FP inside the unit 110c disappears, and the magnetic path FP is formed inside the unit 110a, which in turn causes the rotor 120 to receive a force in which the reactance of the magnetic path FP of the unit 110a approaches the minimum. That is, as illustrated in the rightmost drawing of FIG. 6, the rotor 120 moves, while rotating about the rotation axis 120J, toward the first outer tooth 105A having the higher magnetic permeability than the gap 106A (FIG. 1) in the unit 110a. For the sake of convenience, this operation will be referred to as phase 3.

Thereafter, it is possible to continue the rotation of the rotor 120 by repeating the phases 1 to 3 described above sequentially.

In addition, when all of the permanent magnets PM are brought into a demagnetization state by, for example, applying a demagnetization pulse larger than the coercivity of each of the permanent magnets PM to all of the permanent magnets PM without energizing any of the coils 104 at any timing upon completion of the phase 1, the phase 2, or the phase 3, it is possible to rotate the rotor 120 or the sun gear 140 freely with almost no resistance by applying a force from the outside. However, a frictional resistance between each gear and an inertial resistance of each gear are unavoidable. Further, the frictional resistance and the inertial resistance thereof are amplified by gear ratios of the stator 100, the planetary gear 130, and the sun gear 140.

If the coil 104 to be energized is not switched at any timing upon the completion of the phase 1, the phase 2, or the phase 3, it is possible to fix the state, i.e., a position of the rotor 120. That is, it is possible to use the actuator 10 as a brake.

[2-3 Effects of Actuator 10]

As described above, according to the actuator 10 of the present embodiment, it is possible to use the actuator 10 as an integration of three devices, i.e., a motor, a gear, and a brake. Thus, the components are shared as compared with a case where three independent components including, for example, the motor, the gear, and the brake are gathered. Hence, it is possible to improve a ratio of an output torque to a total weight.

In addition, the actuator 10 has a structure in which acting the coil 104 for a very short time suffices to magnetize the permanent magnet PM. Hence, it is possible to reduce a power consumption especially at the time of a low-speed operation.

In addition, it is possible to set the magnetization and the demagnetization of the permanent magnet PM by the on/off operation of the coil 104. Thus, it is possible to easily achieve an operation of rotating, for example, the rotor 120 and the sun gear 140 and an operation of braking, for example, the rotor 120 and the sun gear 140.

In addition, an operation is made possible by disposing at least one permanent magnet PM for each unit 110. Hence, it is advantageous in terms of weight reduction and cost reduction.

### 3. MODIFICATION EXAMPLES

### Modification Example 1

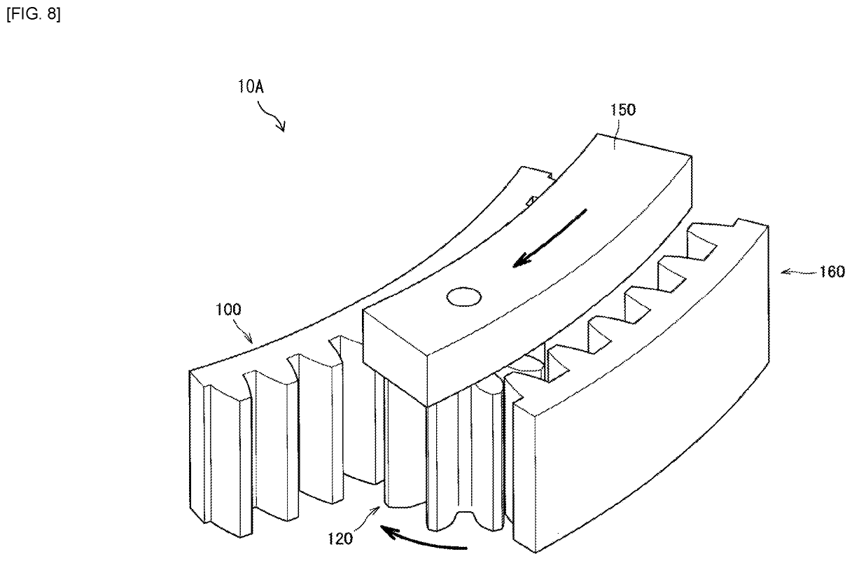

In one embodiment described above, an example in which the carrier 150 supports the rotor 120 has been described, but the present disclosure is not limited to such an example. For example, as with an actuator 10A illustrated in FIG. 8, a ring gear 160 disposed on the opposite side of the stator 100 with respect to the rotor 120 may rotatably hold the rotor 120.

### Modification Example 2

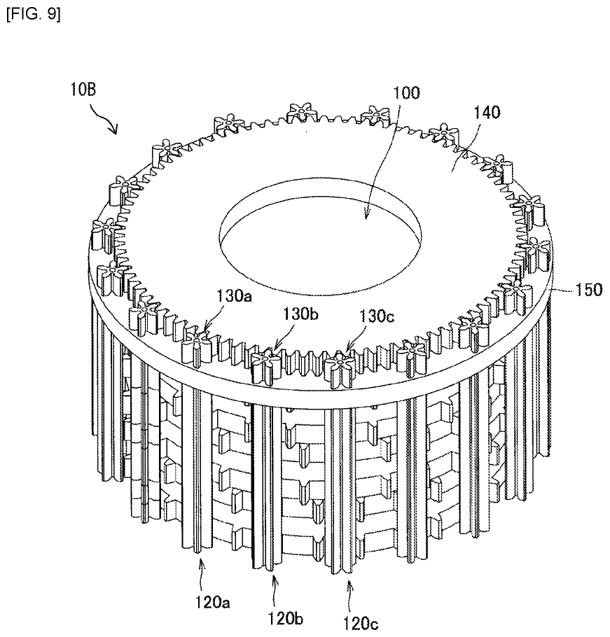

In the embodiment described above, an example has been mainly described in which the actuator 10 includes only one rotor 120 as illustrated in FIG. 1, etc., but the present disclosure is not limited to such an example. For example, a plurality of rotors 120 may be provided as with an actuator 10B illustrated in FIG. 9. FIG. 9 is a diagram illustrating an example of an external configuration of the actuator 10B according to modification example 2.

Referring to FIG. 9, in the modification example 2, the individual rotors 120 each may rotate about the center axis of the stator 100 with the teeth arranged on the outer circumferential surface of the rotor 120 being engaged with the first outer teeth 105 arranged on the outer circumferential surface of the stator 100. In addition, the plurality of rotors 120 each may be disposed at substantially equal intervals from each other in a circumferential direction of the outer circumferential surface of the stator 100.

The actuator 10B according to the modification example 2 includes a large number of rotors 120 and a large number of planetary gears 130 as illustrated in FIG. 9, for example. This is advantageous in that the sun gear 140 is less susceptible to breakage because the large number of planetary gears 130 each rotate with the large number of planetary gears 130 being engaged with the sun gear 140. For example, in an existing wave gear speed reducer, an outer gear on the input shaft side (more detail, a flexspline) and an inner gear on the output shaft side (more detail, a circular spline) rotate with only two teeth being engaged with each other. In contrast, in the actuator 10B according to the modification example 2, each of the large number of planetary gears 130 and the sun gear 140 rotate while being engaged together with each other. Hence, each gear is less likely to break as compared with existing wave gear speed reducers.

In addition, it is possible for the actuator 10B according to the modification example 2 to include the planetary gears 130 that are larger in number than the number of planetary gears in existing planetary gear speed reducers. Hence, each gear is less likely to break as compared with existing planetary gear speed reducers.

### Modification Example 3

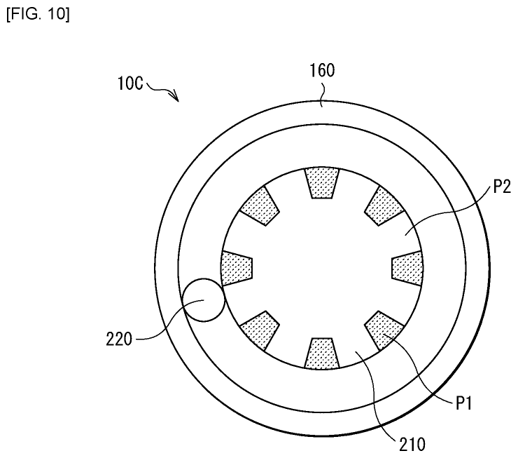

Further, in the actuator 10 according to one embodiment described above, the outer teeth gears having the first outer teeth 105 are used as the disks 101 and 102; however, the present disclosure is not limited thereto. For example, it is possible to use a disk-shaped member as with a disk 210 of an actuator 10C according to modification example 3 illustrated in FIG. 10, for example. In the disk 210, the first part P1 having the first magnetic permeability and the second part P2 having the second magnetic permeability higher than the first magnetic permeability are alternately disposed at an outer edge of the disk 210. Here, the disk 210 has a smooth outer circumferential surface. The second part P2 includes a high magnetic permeability material such as soft ferrite. In addition, as the first part P1, it is possible to use a nonmagnetic material such as resin and or aluminum. Further, in a case of using the disk 210, it is possible to use a substantially cylindrical rotor 220 having a smooth outer circumferential surface, instead of the rotor 120 which is the outer teeth gear.

### INDUSTRIAL APPLICABILITY

The actuator according to the present disclosure has an industrial applicability as follows.

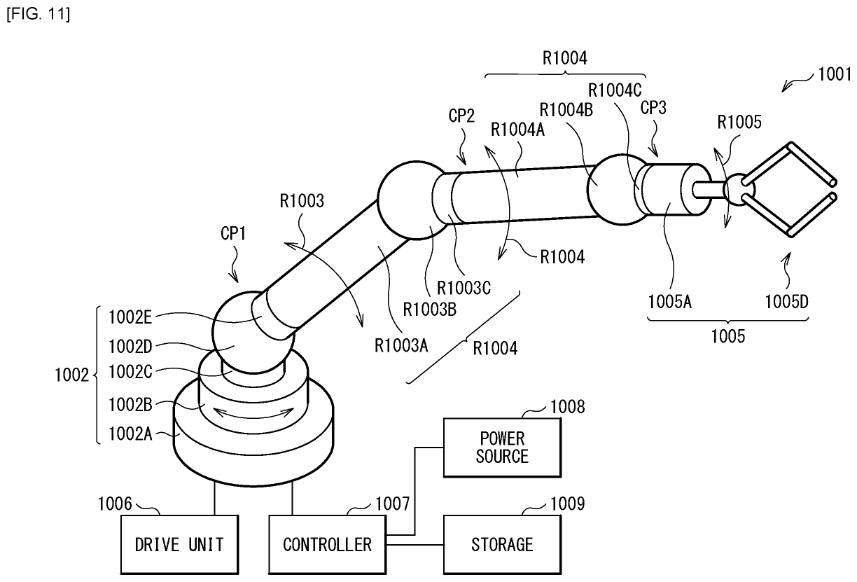

The actuator according to the present disclosure is applicable to, for example, a robot arm 1001 illustrated in FIG. 11. FIG. 11 is a schematic diagram illustrating an example of an entire configuration of the robot arm 1001. The robot arm 1001 has a structure in which a base end section 1002, an intermediate section 1003, an intermediate section 1004, and a tip end section 1005 are coupled in this order. The structure in which the base end section 1002, the intermediate section 1003, the intermediate section 1004, and the tip end section 1005 are coupled in order is referred to as an arm unit for convenience. The robot arm 1001 further includes, for example, a controller 1007 and a power source 1008, in addition to the arm unit.

The base end section 1002 has: a base section 1002A to be fixed to a floor surface or the like, for example; a rotary section 1002B; and a joint section 1002D. Here, the actuator 10 according to the present disclosure may be disposed at the joint section 1002D. The rotary section 1002B is a member having a substantially cylindrical shape, and is rotatably provided in a rotation direction R1002 indicated by an arrow with respect to the base section 1002A. The joint section 1002D is fixed to the rotary section 1002B, and is rotatable in the rotation direction R1002 integrally with the rotary section 1002B. An arm section 1003A is attached to the joint section 1002D. The arm section 1003A is rotatably provided in a rotation direction R1003 indicated by an arrow about the joint section 1002D by the actuator 10 provided at the joint section 1002D.

The intermediate section 1003 has a joint section 1003B in addition to the arm section 1003A. The intermediate section 1004 has an arm section 1004A and a joint section 1004B. Here, the actuator 10 according to the present disclosure may also be disposed at the joint section 1003B and the joint section 1004B. The tip end section 1005 includes a body 1005A and a manipulator 1005B.

In the robot arm 1001, the actuator 10 built in each of the joint sections 1002D, 1003B, and 1004B is drivable under the control of the controller 1007. The robot arm 1001 makes it possible to achieve a high output torque especially at the time of a low-speed operation while achieving a compact and lightweight configuration, which is advantageous in weight reduction and cost reduction. Further, the robot arm 1001 makes it possible to use the actuator 10 as a braking device by the on/off control of the coil 104. Accordingly, the robot arm 1001 is highly safe, making it suitable for use as a device that performs various operations in a public environment. Examples of applicability include: assisting transportation work, etc., in a store or the like; farming work indoors and outdoors; medical practice; transportation work; cargo handling work; and appearance inspection work of products or the like indoors and outdoors.

Although the present disclosure has been specifically described with reference to the embodiment and its modification examples, the present disclosure is not limited to the above embodiment and the like, and various modifications can be made.

For example, the configurations, shapes, materials, numerical values, and the like described in the above embodiment and modification examples thereof are merely illustrative, and configurations, shapes, materials, numerical values, and the like different from those may be used as necessary.

In addition, it is possible to combine configurations, etc., of the above-described embodiment and the modification examples thereof with each other as long as they do not depart from a gist of the present disclosure.

For example, the embodiment described above exemplifies a case in which the pillar 103 is configured by a stack structure of the sensor 107 and the permanent magnet PM as illustrated in FIG. 2, but the present disclosure is not limited thereto. For example, all of the pillars 103 may be configured by the permanent magnet PM, or the pillar 103 may include any other component in addition to the permanent magnet PM and the sensor 107.

As described above, a magnetic recording medium according to one embodiment of the present disclosure makes it possible to reduce the entire thickness, and to maintain a good electromagnetic conversion characteristic even after performing repeated recording or repeated reproduction.

Note that the effect of the present disclosure is not limited thereto, and any of the effects described in this specification may suffice. Moreover, the present technology may be configured as follows.
(1)

An actuator including:

a stator having a disk, a pillar including a permanent magnet, and a coil wound around the pillar; and

a rotor provided movably along an outer edge of the disk with the rotor being in contact with the outer edge of the disk, in which

the coil is configured to form, through energization of the coil, a magnetic path that passes through the disk, the pillar, and the rotor, and

the disk includes a first part and a second part that are disposed alternately along the outer edge of the disk, the first part having a first magnetic permeability, the second part having a second magnetic permeability that is higher than the first magnetic permeability.
(2)

The actuator according to (1), in which the stator further includes a sensor that is provided at a portion of the magnetic path and detects a magnetic flux of the magnetic path.
(3)

The actuator according to (1), further including a controller that controls a voltage to be supplied to the coil on the basis of the magnetic flux detected by the sensor.
(4)

The actuator according to any one of (1) to (3), in which the stator has a configuration in which a plurality of units is stacked, the plurality of units each having the disk, the pillar, and the coil.
(5)

The actuator according to (4), further including a controller that forms the magnetic path in the plurality of units and magnetizes the permanent magnet by sequentially energizing the coil in each of the plurality of units.
(6)

The actuator according to (5), in which the controller demagnetizes the previously-magnetized permanent magnet, upon sequentially energizing the coil in each of the plurality of units.
(7)

The actuator according to any one of (4) to (6), in which the rotor is in contact with the outer edge of the disk of each of the plurality of units.
(8)

The actuator according to any one of (4) to (7), in which the second parts of the disks in the respective plurality of units are located at positions that are different from each other when viewed in a stacking direction of the plurality of units.
(9)

The actuator according to any one of (4) to (8), in which the plurality of units includes three or more units.
(10)

The actuator according to any one of (4) to (9), in which the disk includes a first outer tooth as the first part and a gap as the second part, and the rotor includes a second outer tooth that comes into engagement with the first outer tooth.

The actuator according to any one of (1) to (10), in which the coil is configured to impart a magnetic field having a magnetic flux density that is greater than a coercivity of the permanent magnet.
(12)

The actuator according to any one of (1) to (11), in which the rotor has a third magnetic permeability that is higher than the first magnetic permeability.
(13)

The actuator according to any one of (1) to (12), in which

the disk includes a first disk and a second disk, and

the pillar and the coil are interposed between the first disk and the second disk.
(14)

The actuator according to any one of (1) to (13), further including a ring gear that rotatably holds the rotor between the ring gear and the stator.

The present application claims the benefit of Japanese Priority Patent Application JP2019-165309 filed with the Japan Patent Office on Sep. 11, 2019, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. An actuator comprising:
a stator having a disk, a pillar including a permanent magnet, and a coil wound around the pillar; and
a rotor provided movably along an outer edge of the disk with the rotor being in contact with the outer edge of the disk, wherein
the coil is configured to form, through energization of the coil, a magnetic path that passes through the disk, the pillar, and the rotor, and
the disk includes a first part and a second part that are disposed alternately along the outer edge of the disk, the first part having a first magnetic permeability, the second part having a second magnetic permeability that is higher than the first magnetic permeability.

2. The actuator according to claim 1, wherein the stator further includes a sensor that is provided at a portion of the magnetic path and detects a magnetic flux of the magnetic path.

3. The actuator according to claim 2, further comprising a controller that controls a voltage to be supplied to the coil on a basis of the magnetic flux detected by the sensor.

4. The actuator according to claim 1, wherein the stator has a configuration in which a plurality of units is stacked, the plurality of units each having the disk, the pillar, and the coil.

5. The actuator according to claim 4, further comprising a controller that forms the magnetic path in the plurality of units and magnetizes the permanent magnet by sequentially energizing the coil in each of the plurality of units.

6. The actuator according to claim 5, wherein the controller demagnetizes the previously-magnetized permanent magnet, upon sequentially energizing the coil in each of the plurality of units.

7. The actuator according to claim 4, wherein the rotor is in contact with the outer edge of the disk of each of the plurality of units.

8. The actuator according to claim 4, wherein the second parts of the disks in the respective plurality of units are located at positions that are different from each other when viewed in a stacking direction of the plurality of units.

9. The actuator according to claim 4, wherein the plurality of units comprises three or more units.

10. The actuator according to claim 4, wherein
the disk includes a first outer tooth as the first part and a gap as the second part, and
the rotor includes a second outer tooth that comes into engagement with the first outer tooth.

11. The actuator according to claim 1, wherein the coil is configured to impart a magnetic field having a magnetic flux density that is greater than a coercivity of the permanent magnet.

12. The actuator according to claim 1, wherein the rotor has a third magnetic permeability that is higher than the first magnetic permeability.

13. The actuator according to claim 1, wherein
the disk comprises a first disk and a second disk, and
the pillar and the coil are interposed between the first disk and the second disk.

14. The actuator according to claim 1, further comprising a ring gear that rotatably holds the rotor between the ring gear and the stator.
